(19) United States
(12) Patent Application Publication
(10) Pub. No.: US 2016/0128150 A1
(43) Pub. Date: May 5, 2016

(54) LED CURRENT CONTROLLER

(71) Applicant: TEXAS INSTRUMENTS INCORPORATED, Dallas, TX (US)

(72) Inventors: Chenjie RUAN, Shanghai (CN); Guofeng JIN, Shanghai (CN)

(21) Appl. No.: 14/644,520

(22) Filed: Mar. 11, 2015

Related U.S. Application Data
(63) Continuation of application No. PCT/CN2014/089889, filed on Oct. 30, 2014.

(51) Int. Cl. H05B 33/08

(52) U.S. Cl. CPC H05B 33/0827; H05B 33/0815

(57) ABSTRACT

A method comprises regulating, by a modulator of a LED controller, a plurality of current sinks to operate in a linear region of a current-to-voltage curve which is associated with a constant value of resistance, wherein each current sink is coupled to each of a plurality of LED strings, receiving, by the modulator, information of first current flowing through each of a plurality of LED strings, processing, by a control logic coupled to the modulator, the information of the first current, and based on the processed information of the first current, providing, by the control logic, at least two choices of information of second current that is to be flown through each respective LED string.

### CROSS-REFERENCE TO RELATED APPLICATION

This is a continuation of copending International Application No. PCT/CN2014/089889, with an international filing date of Oct. 30, 2014, which designated the United States and is hereby fully incorporated herein by reference for all purposes.

### BACKGROUND

In a liquid crystal display (LCD) matrix display, and in solid state lighting applications, such as street lighting, typically light emitting diodes (LEDs) form a plurality of strings of serially connected LEDs. Due to variations of manufacturing, temperature, and age, each LED string may exhibit distinctive voltage drops. This distinctive voltage drop from each of the LED string may cause a undesirable amount of heat dissipation.

### SUMMARY

Systems and methods to control a plurality of light emitting diode (LED) strings are disclosed herein. In an embodiment, a LED controller includes a voltage converter, a modulator, a plurality of current sinks, and a control logic coupled to the modulator. The voltage converter is configured to convert an input voltage to a regulated voltage level for each of a plurality of LED strings, wherein each of the plurality of LED strings includes a plurality of LEDs. Each LED string is to be connected to a current sink. The modulator coupled to the current sinks is configured to regulate each current sink operating in a linear region of a current-versus-voltage curve, and to receive first current that flows through each LED string and a first duty cycle associated with the first current. The control logic, based on digitized information of the first current from each LED string, is configured to provide digitized information of second current which includes two choices for each respective LED string so as, over the second current flowing through each LED string, to decrease a voltage drop across the current sink for each LED string. More specifically, the digitized information of the second current for each LED string includes a duty cycle and a current level associated with each second current.

In another embodiment, a system includes a LED controller and a plurality of LED strings. More specifically, the LED controller includes a voltage converter to power the plurality of LED strings, a modulator, a control logic coupled to the modulator, and a plurality of current sinks. Each current sink is coupled to each of the plurality of LED strings and the plurality of the current sinks is coupled to the modulator of the LED controller. Based on a feedback signal received from each current sink, the modulator is configured to regulate each current sink to operate in a linear region of a current-versus-voltage curve which is associated with a constant value of resistance. The control logic is configured to process information of first current flowing through each LED string, and based on the processed information, to provide updated information of second current that the modulator is to use to operate each LED string.

In a further embodiment, a method comprises regulating, by a modulator of a LED controller, a plurality of current sinks to operate in a linear region of a current-to-voltage curve which is associated with a constant value of resistance, wherein each current sink is coupled to each of a plurality of LED strings, receiving, by the modulator, information of first current flowing through each of a plurality of LED strings, processing, by a control logic coupled to the modulator, the information of the first current, and based on the processed information of the first current, providing, by the control logic, at least two choices of information of second current that is to be flown through each respective LED string.

In yet another embodiment, a LED controller includes a boost converter, a modulator, a plurality of current sinks, and a control logic coupled to the modulator. The boost converter is configured to step up an input voltage to a regulated voltage level at an output voltage node, wherein the output voltage node is usable to power a plurality of LED strings and each of the plurality of LED strings includes a plurality of LEDs. Each of the plurality of current sinks is coupled to each of the plurality of LED strings and configured to compensate a forward voltage drop generated by each coupled LED string. The modulator coupled to the current sinks is configured to regulate each current sink operating in a linear region of a current-versus-voltage curve, and to receive first current that flows through each LED string and a first duty cycle associated with the first current. The control logic, based on digitized information of the first current from each LED string, is configured to provide digitized information of second current which includes two choices for each respective LED string so as, over the second current flowing through each LED string, to decrease a magnitude of the forward voltage drop. More specifically, the digitized information of the second current for each LED string includes a duty cycle and a current level associated with each second current. While the control logic chooses first digitized information of the second current, the digitized information of the second current includes the same average current over time of the second current as the average current over time of the first current, and wherein the modulator is to use the digitized information of the second current to operate the respective current sink for each LED string. On the other hand, while the control logic chooses second digitized information of the second current, the control logic causes a time period during which the second current is active to be equivalent to a time period that is a duty cycle of the first current divided by an integer.

### BRIEF DESCRIPTION OF THE DRAWINGS

For a detailed description of exemplary embodiments of the invention, reference will now be made to the accompanying drawings in which:

FIG. 1 a block diagram of a system including a light emitting diode (LED) controller in accordance with various embodiments;

FIG. 2 shows a further illustration of a LED controller in accordance with various embodiments;

FIGS. 3A and 3B show exemplary waveforms of a first current and an updated current regulated by a LED controller in accordance with various embodiments; and

FIG. 4 shows a flow chart to illustrate regulating, by a LED controller, current flowing through a LED string in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Light emitting diodes (LEDs), and in particular high intensity and medium intensity LED strings, are rapidly coming into wide use for lighting applications. LEDs with an overall high luminance are useful in a number of applications including backlighting for liquid crystal display (LCD) based monitors and televisions, collectively hereinafter related to as a matrix display, as well as for general lighting applications.

In various LCD matrix displays, and in solid state lighting applications, such as street lighting, typically the LEDs are supplied in a plurality of strings of serially connected LEDs. As such, the constituent LEDs of each LED string share a common current.

LEDs providing high luminance exhibit a range of forward voltage drops, denoted as V_{f}. The luminance of each LED is primarily a function of current flowing through the LED. Due to the manufacturing variation, operating temperature, and age, however, each LED may exhibit a different V_{f}, which may result in a significant variation of voltage drop for each LED string in a large array of LEDs. The array of LEDs is typically made up of multiple LED strings. The various LED strings may be connected in parallel with each other. This variation of voltage drop across each of the LED strings may be compensated by serially connecting a dissipative element (e.g., a resistor or a semiconductor device) to compensate the varying voltage drop associated with each LED string. However, the dissipative element may suffer from an issue of heat dissipation, as the dissipative element is a significant source of heat. More specifically, while the dissipative element provides the compensated voltage drop for each associated LED string, the big variation of the voltage drops (string by string) may result in undesirable heat dissipation. Thus, the disclosed embodiments provide a controller to cause the LED array to function normally while concurrently keeping the amount of heat generated by the dissipative element at a relatively low level.

In a preferred implementation, the controller to drive the LED array may be an individually-modulated multi-channel controller. In other words, each LED string (channel) is individually modulated by the controller in order to have a consistent and balanced backlight (i.e., brightness) for the LED array, which means that each LED string of the LED array share an equal brightness. As mentioned above, due to the variation of LED forward voltage drop, given a constant voltage applied to the LED strings, a different level of current may flow through each LED string, which in turn may result in a non-balanced backlight for the LED array. In this regard, in some preferred embodiments, the brightness of the LED string is determined, not only by a current level flowing through each LED string, but also by pulse width modulated (PWM) dimming which uses a PWM signal that includes a variable duty cycle to control the brightness of the LED string. The brightness of the LED string is determined by a product of the current level flowing through the LED string and the duty cycle of the PWM signal. Details of implementing the PWM duty cycle and the current level flowing through the LED string will be described below.

Embodiments of the disclosed invention provide systems and methods to decrease a voltage drop across each dissipative element that is serially connected to each LED string of a LED array so as to keep the amount of heat generated by the dissipative element as low as possible. More specifically, while concurrently maintaining an equal brightness for each LED string, the disclosed embodiments provide two choices of updated current information to each dissipative element. Based on the updated current information, each dissipative element may advantageously lower the amount of heat generated by itself, which results from the forward voltage drop of the connected LED string.

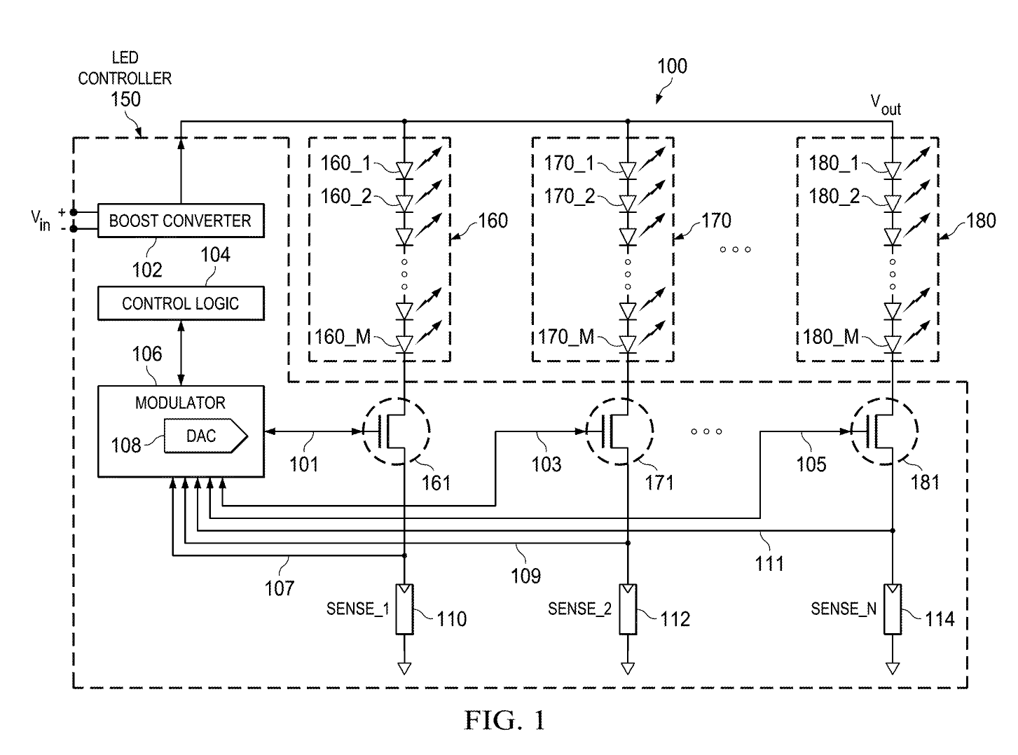

FIG. 1 shows a block diagram of a system 100 including the disclosed LED controller 150 in accordance with various embodiments. The system 100 may include an LCD matrix display (i.e., LED array), or a solid state lighting application such as a taillight/headlight of a vehicle, traffic light, etc. to be controlled by the LED controller 150. The system 100 includes the LED controller 150, and various LED strings (e.g., strings 160, 170, and 180). More specifically, the LED controller 150 further includes a boost converter 102, a control logic 104, a modulator 106 comprising an integrated digital-to-analog converter (DAC) 108, and a dissipative element and current sensing device for each LED. As shown, LED string 160 is associated with a dissipative element 161 and current sensing device 110. LED string 170 is associated with a dissipative element 171 and current sensing device 112, while LED string 180 is associated with a dissipative element 181 and current sensing device 114. Each combination of dissipative element and current sensing device preferably is serially connected to the corresponding LED string.

In some preferred embodiments, the LED strings (e.g., 160, 170, and 180) may form a LED array, wherein the LED array comprises “M×N” LEDs (M, N are positive integers). More particularly, the LED array includes “N” LED strings, and each LED string includes “M” individual LEDs. Typically, as shown in FIG. 1, the LEDs of a particular LED string are electrically coupled in series with each other. More particularly, an anode of a first LED (e.g., 160_1) forms a first terminal of a LED string (e.g., 160), a cathode of the first LED is electrically coupled to an anode of a second LED (e.g., 160_2), and a cathode of an M^{th} 0 LED (e.g., 160_M, the last LED in the string) forms a second terminal of the LED string.

Still referring to FIG. 1 and as explained above, a dissipative element and current sensing device are serially coupled to each LED string. For example, in the LED string 160, a first terminal of the dissipative element 161 is electrically connected to the second terminal of the LED string 160, and a second terminal of the dissipative element 161 is electrically connected to the current sensing device 110. In a preferred embodiment, each dissipative element (e.g., 161, 171, and 181) may be a semiconductor device such as a metal-oxide-semiconductor field-effect transistor (MOSFET), or a bipolar junction transistor (BJT). If the dissipative element is implemented as a MOSFET, the first and second terminals of the dissipative element may be the drain and source terminals of the MOSFET. Each current sensing device (e.g., 110, 112, and 114) may be, for example, a resistor that is configured to sense current flowing through each LED string. More specifically, the sensed current may form a feedback signal (e.g., voltages 107, 109, and 111) that is used by the LED controller 150 to perform additional LED string current regulation, which will be discussed below.

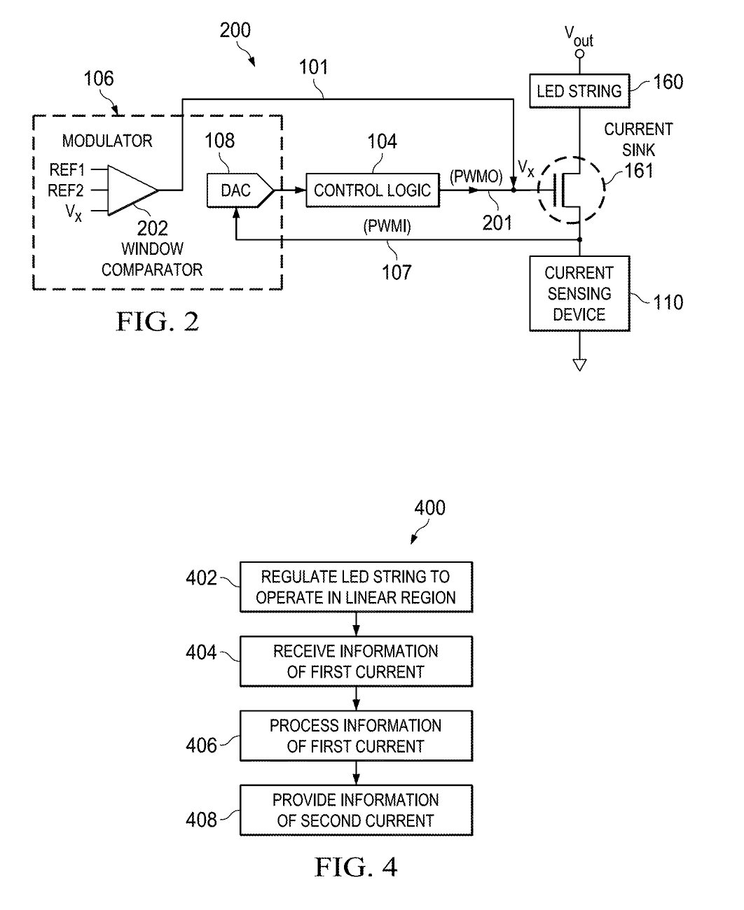

As mentioned above, each dissipative element 161, 171, 181 is configured to compensate the voltage variation due to the forward voltage drop of the LEDs of the corresponding LED string. In addition, in a preferred embodiment, each dissipative element is also configured to regulate the current flowing through LED string corresponding to that dissipative element. Thus, the dissipative element is generally referred to as a “current sink”. Still in a preferred embodiment, the regulation of current through the LED strings may be controlled via the modulator 106. Details of the regulation will be discussed with respect to the further illustration of the modulator 106 in FIG. 2.

In a preferred example, the MOSFET, that is the current sink 161, 171, and 181, for each LED string may be regulated by the modulator 106 to operate in a linear region of a current-versus-voltage curve. More specifically, a gate signal (e.g., 101, 103, and 105) for each MOSFET is provided by the modulator 106 so that each MOSFET can be regulated to operate in the linear region. Operation of the MOSFET in the linear region means that a level for the current flowing through the MOSFET (same current flowing through the coupled LED string) is linearly proportional to a voltage drop across the MOSFET. Moreover, if the MOSFET is not subject to a severe manufacturing variation, the proportionality constant is fixed. In other words, a resistance value (i.e., voltage/current) for all the current sinks may share a common value.

The disclosed embodiments utilize the LED controller 150 to regulate each of the current sinks (e.g., 161, 171, and 181) to operate in the linear region, and moreover, the disclosed LED controller 150 is configured to determine, based on a first current (i.e., the present current), an updated current (i.e., second current) flowing through each LED string so as to reduce the amount of heat (i.e., power) generated by each current sink. As such, regulating, by the LED controller 150, the current flowing each LED string may advantageously provide a lower or minimum power dissipation for a given LED array. Generally, the current flowing through each LED string is a pulse width modulated (PWM) signal. More specifically, the current may periodically transition from a lower level to a higher level. A duty cycle is the percentage of time over a cycle that the current is at a higher level. For example, a 75% duty cycle means that the current of the LED string is a higher level 75% of each cycle. As described above, the brightness of each LED string is determined by the product of the current level and the duty cycle, so in order to keep the brightness constant, the LED controller 150 functions to maintain product of duty cycle and LED string current at a constant value. For example, a first current level may be 0.3 A and associated with a 100% duty cycle. After regulating by the LED controller 150, the current may increase to a second current level of 0.35 A and may be associated with a lower duty cycle of 85%. The product of the first current level and associated duty cycle (0.3×100%=0.3) is equivalent to the product of the second current (0.35×85% 0.3).

Still referring to FIG. 1, preferably, the boost converter 102 of the LED controller 150 is configured to step up an input voltage Vᵢₙ to provide an output voltage Vₒᵤₜ to drive each of the LED strings 160, 170, and 180. Moreover, the output voltage Vₒᵤₜ is preferably to be a constant value after the LED controller 150, based on a predefined current level to flow through the LED string, regulates each of the current sinks 161, 171, 181 to operate in the linear region. In a preferred implementation, the predefined current level is set by a user and provided to the LED controller 150. During initialization of each LED string, or more generally the entire LED array, the LED controller 150 acknowledges the predefined current level and by flowing the predefined current level through each LED string of the LED array, causes the boost converter 102 to provide a gradually increased output voltage Vₒᵤₜ high enough to drive the LED strings. The LED controller 150 further causes the modulator 106 to regulate the current sinks 161, 171, 181 to operate in their linear region. Since each LED string may exhibit a different forward voltage drop, a voltage level at the drain terminal of each current sink may vary. In a preferred embodiment, for a given Vₒᵤₜ, the LED controller 150 is configured to determine a minimum voltage level at the drain terminal for a particular current sink among all the current sinks 161, 171, 181 of the LED array, and simultaneously determines whether the particular current sink operates in the linear region. Once the particular current sink is operated in the linear region, the output voltage Vₒᵤₜ is determined. Also, the minimum voltage level at the drain terminal for the particular current sink is determined. Preferably, the boost converter 102 of the LED controller 150 maintains the output voltage Vₒᵤₜ to drive the remaining LED strings of the LED array. More particularly, the output voltage may be expressed as Vₒᵤₜ=V_{F}+V_{dropout}. The voltage V_{F} represents the forward voltage drop of each LED of a given LED string (e.g., 160). The voltage V_{dropout} represents the voltage drop across the current sink (e.g., 161). In some preferred implementations, a minimum V_{dropout} is the minimum voltage level at the drain terminal for the particular current sink.

Continuing with the above example in which the first current and associated duty cycle are 0.3 A and 100%, and the second current and associated duty cycle are 0.35 A and 85%, duty cycle which are regulated by the LED controller 150, assume the constant Vₒᵤₜ has been regulated by the LED controller 150 to drive the LED string. Due to the forward voltage drop of the LEDs, a compensating voltage drop (i.e., V_{dropout}), across the current sink may be implemented while flowing the first current through one of the LED strings. Since the current sink operates in the linear region, both of the first and second currents flowing through the current sink for the given LED string passes through a common value of resistance, i.e., the conductive resistance of the MOSFET, for example, 0.2Ω. As such, the power generated by the current sink while passing the first and second currents may be respectively expressed as, V_{dropout}×the first current level×associated duty cycle. Assuming a voltage drop across the current sink of 0.3V, this power is 3V×0.3 A×100%=0.9 W for the first current. Further, the second current level²×associated duty cycle×the conductive resistance of the MOSFET is 0.35 A²×85%×0.2=Ω0.02 W. The difference of the dissipated power is 0.9 W−0.02 W=0.88 W. As a result, 0.68/0.9=97% power may be saved by LED controller 150 causing the second current to flow through the LED string and the coupled current sink.

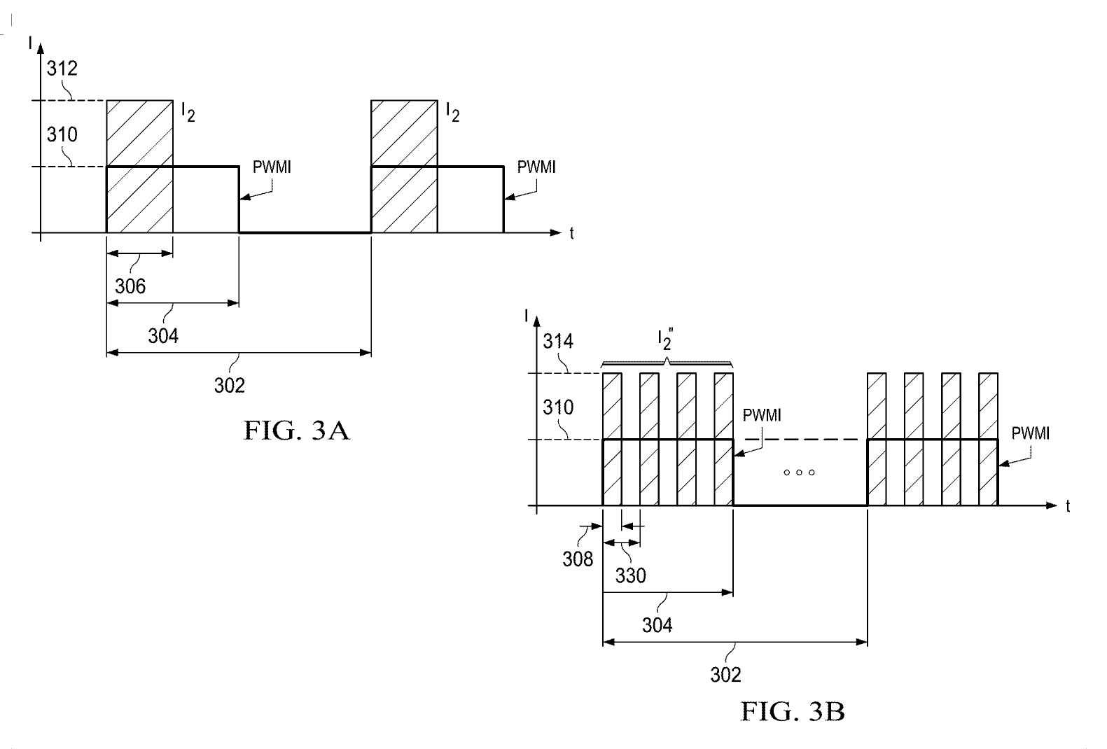

By regulating each of the current sinks (e.g., 161, 171, and 181) to operate in the linear region and the current (including the current level and associated duty cycle) flowing through each current sink, the amount of heat, or energy, dissipation generated by the current sinks may be controlled and thus reduced. In a preferred embodiment, based on the predefined current level, once Vₒᵤₜ is determined by the boost converter 102, a particular channel (LED string) in which the minimum value of V_{dropout} occurs is determined. By using the minimum V_{dropout} from that channel as a reference, the LED controller 150 regulates current flowing through each of the other remaining channels of the LED array so as to reduce a total power dissipation of the LED array. Preferably, V_{dropout} for each of the other remaining channels is greater than the minimum V_{dropout} and the regulated current flowing each of the remaining channels is greater than the predefined current level. Details of how the LED controller 150 associates the second current (updated current) with the first current (e.g., the predefined current level) will be provided with respect to waveforms of the first and second current in FIG. 3.

FIG. 2 shows an exemplary block diagram 200 to further illustrate the disclosed LED controller 150 to regulate the LED array in accordance with various embodiments. For purpose of illustration, only one channel (LED string 160) of the LED array is included in FIG. 2, but the principle below can be generalized to operate any or all of the LED strings of the LED array. As shown in FIG. 2, the modulator 106 further includes a window comparator 202. In the example of FIG. 2, the window comparator 202 includes three inputs, Ref 1, Ref 2, and Vₓ. Ref 1 and Ref 2 are reference voltage levels defined by the user, and Vₓ is preferably a voltage level at the gate terminal of the current sink 161.

The window comparator 202 preferably is configured to compare Vₓ with the reference voltage levels Ref 1 and Ref 2. In a preferred embodiment, as long as Vₓ is between Ref 1 and Ref 2, Vₓ is used to regulate the corresponding current sink (e.g., 161) to work in the linear region. As such, the window comparator 202 may sense Vₓ on the fly and continuously provide a voltage signal 101 to Vₓ so as to keep the current sink 161 operating in the linear region.

As described above, the current sensing device 110 is configured to sense the current flowing through the corresponding LED string 160 and current sink 161. In a preferred implementation, the sensed current (e.g., encoded in signal 107) is a PWM signal that is a feedback signal to the DAC 108 of the modulator. Since the signal 107 is an input signal to the DAC 108, the signal 107 may be referred to as “PWMI”. After the DAC 108 receives the signal 107, the DAC 108 is configured to process and convert the signal 107 into a digital signal so as to provide the control logic 104 digitized information of the PWMI. The conversion of the analog signal 107 may include calculating a current level and associated duty cycle of the sensed PWMI (i.e., signal 107).

Still referring to FIG. 2, once the control logic 104 receives the digitized information regarding PWMI, in a preferred embodiment, the control logic 104 is configured to provide two choices of updated current (updated current level and corresponding duty cycle) to the current sink 161. That is, a first updated current level and corresponding duty cycle or a second updated current level and corresponding duty cycle may be provided by the control logic 104. Either of these two choices is intended to reduce V_{dropout} of the coupled current sink, and a determination of one of these two choices may be made by the control logic 104 or by the user. As shown in FIG. 2, the determined choice is signal 201 which is preferably a PWM signal as well. Since it is an output of the LED controller 150, it may be referred to as “PWMO”.

FIGS. 3A and 3B show examples of waveforms of the first current (e.g., PWMI) and second current (e.g., PWMO) which represent originally sensed current flowing through the channel and updated current regulated by the LED controller 150 to flow through the dedicated channel in accordance with various embodiments. More specifically, I₂ in FIG. 3A represents a first choice of the updated current provided by the control logic 104, and I₂″ in FIG. 3B represents a second choice of the updated current provided by the control logic 104.

In FIG. 3A, the PWMI includes a periodic cycle 302, an active time period 304, and a current level 310. After regulating by the LED controller 150, I₂ includes an updated current level 312 and an associated active time period 306, however, shares the common periodic cycle 302 with the PWMI. The active time periods 304 and 306 may be calculated as the periodic cycle 302 times respective duty cycles for the PWMI and I₂. In a preferred embodiment, the current level 312 is greater than the current level 310 so as to reach a reduced V_{dropout} across the corresponding current sink (V_{dropout}=Vₒᵤₜ−I×R_{LED}, wherein “I” is the current level of the current flowing through each channel, Vₒᵤₜ is kept approximately constant as described above and R_{LED} is a resistance value of the coupled LED string which is unchanged, so that a larger current level leads to a smaller V_{dropout}). More specifically, the control logic 104 is configured to keep the brightness of the LED string generally unchanged, and thus the product of 310 and 304 is equivalent to the product of 306 and 312.

In FIG. 3B, based on the same PWMI, the second choice of PWMO provided by the control logic 104 is shown as I₂″, wherein I₂″ includes a periodic cycle 330, an active time period 308, and an updated current level 314. In a preferred embodiment, the active time period 308 of I₂″ is calculated as a duty cycle for the updated I₂″ times the corresponding periodic cycle 330. More specifically, the active time period 308 for the updated current equals the active time period for the PWMI divided by an integer.

FIG. 4 shows a flow chart 400 to operate the LED array by the disclosed LED controller 150 in accordance with various embodiments. The flow chart 400 begins at block 402 by regulating, for example by the modulator 106 of the LED controller 150, the current sink electrically coupled to each LED string of the LED array to operate in the linear region. Preferably, the current sink is a MOSFET, and while the MOSFET works in the linear region, a constant value of resistance, that is, a fixed slope of a current-versus-voltage curve, is exhibited.

The flow chart 400 continues at block 404 with receiving, by the modulator 106, information of the first current flowing through each channel (LED string and coupled current sink). The information includes a current level and associated duty cycle of the first current. Subsequently, at block 406, the information of the first current is digitized by the DAC 108, and processed by the control logic 104.

Still referring to FIG. 4, based on the digitized information of the first current, the flow chart 400 continues at block 408 with providing, by the control logic 104, information of the second current that is to be flown through the respective channel. In a preferred implementation, two choices of the second current is provided by the control logic 104, which are explained individually with respect to FIGS. 3A and 3B. More specifically, the information of the second current also includes a current level and associated duty cycle of the second current.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A light emitting diode (LED) controller, comprising:
a voltage converter configured to convert an input voltage to a regulated voltage level for each of a plurality of LED strings, wherein each of the plurality of LED strings includes a plurality of LEDs;
a plurality of current sinks, each of the plurality of current sinks is to be connected to each LED string;
a modulator coupled to the current sinks, the modulator configured to regulate each current sink operating in a linear region of a current-versus-voltage curve, and to receive first current that flows through each LED string and a first duty cycle associated with the first current; and
a control logic coupled to the modulator, and, based on digitized information of the first current from each LED string, configured to provide digitized information of second current which includes two choices for each respective LED string so as, over the second current flowing through each LED string, to decrease a voltage drop across the current sink for each LED string;
wherein the digitized information of the second current for each LED string includes a duty cycle and a current level associated with each second current.

2. The LED controller of claim 1 wherein while the control logic chooses first digitized information of the second current, the digitized information of the second current includes the same average current over time of the second current as the average current over time of the first current, and wherein the modulator is to use the digitized information of the second current to operate the respective current sink for each LED string.

3. The LED controller of claim 2 wherein the first digitized information of the second current includes a product value of the first current times the first duty cycle which equals a product value of the second current times the second duty cycle.

4. The LED controller of claim 1 wherein while the control logic chooses second digitized information of the second current, the control logic causes a time period during which the second current is active to be equivalent to a time period that is a duty cycle of the first current divided by an integer.

5. The LED controller of claim 1 wherein the current sink is a metal oxide semiconductor field effect transistor (MOSFET).

6. The LED controller of claim 5 wherein the modulator is configured to regulate, by a comparator of the modulator, a signal at a gate terminal of each current sink so as to maintain each current sink to operate in a linear region.

7. The LED controller of claim 1 wherein the modulator includes a digital-to-analog converter (DAC) that is configured to provide digitized information of the received current to the control logic, wherein the digitized information includes a duty cycle associated with the received current and a current level for the received current.

8. A system, comprising:
a light emitting diode (LED) controller, comprising:
a voltage converter;
a modulator;
a plurality of current sinks;
a control logic coupled to the modulator; and
a plurality of LED strings, powered via the voltage converter;
wherein each current sink coupled to each of the plurality of LED strings and the plurality of the current sinks coupled to the modulator of the LED controller;
wherein, based on a feedback signal received from each current sink, the modulator is configured to regulate each current sink to operate in a linear region of a current-versus-voltage curve which is associated with a constant value of resistance; and
wherein the control logic is configured to process information of first current flowing through each LED string, and based on the processed information, to provide updated information of second current that the modulator is to use to operate each LED string.

9. The system of claim 8 wherein the information of the first and second current includes a current level and a duty cycle for the respective current, wherein the information of the first current for each LED string that the control logic processes is received via the modulator, and the control logic provides the information of the second current to the modulator.

10. The system of claim 9 wherein the information of the second current includes two choices that include: (a) an average current level of the second current which is the same as an average current level of the first current, and (b) the duty cycle for the second current which is less than the duty cycle of the first current.

11. The system of claim 10 wherein the first choice further includes a product value of the first current level times the duty cycle for the first current which equals a product value of the second current level times the duty cycle for the second current.

12. The system of claim 10 wherein the second choice includes the duty cycle of the second current equaling a duty cycle value that is the duty cycle of the first current divided by an integer.

13. The system of claim 8 wherein the current sink is a metal oxide semiconductor field effect transistor (MOSFET).

14. The system of claim 8 wherein the modulator includes a digital-to-analog converter (DAC) that is configured to digitize the first current so as to provide digitized information of the first current to the control logic, wherein the digitized information includes a duty cycle associated with the first current and a current level for the first current.

15. A method, comprising:
regulating, by a modulator of a light emitting diode (LED) controller, a plurality of current sinks to operate in a linear region of a current-to-voltage curve which is associated with a constant value of resistance, wherein each current sink is coupled to each of a plurality of LED strings;
receiving, by the modulator, information of first current flowing through each of a plurality of LED strings;
processing, by a control logic coupled to the modulator, the information of the first current;
based on the processed information of the first current, providing, by the control logic, at least two choices of information of second current that is to be flown through each respective LED string.

16. The method of claim 15 wherein the information of the first and second current includes a current level and a duty cycle for the respective current.

17. The method of claim 16 wherein providing a first choice includes calculating a product value of a first current level times the duty cycle for the first current to equal a product value of a second current level times the duty cycle for the second current.

18. The method of claim 16 wherein providing a second choice includes calculating the duty cycle for the second current to equal a duty cycle value that is the duty cycle of the first current divided by an integer.

19. A light emitting diode (LED) controller, comprising:
a boost converter configured to step up an input voltage to a regulated voltage level at an output voltage node, wherein the output voltage node is usable to power a plurality of LED strings and each of the plurality of LED strings includes a plurality of LEDs;
a plurality of current sinks, each of the plurality of current sinks coupled to each of the plurality of LED strings and configured to compensate a forward voltage drop generated by each coupled LED string;
a modulator coupled to the current sinks, the modulator configured to regulate each current sink operating in a linear region of a current-versus-voltage curve, and to receive first current that flows through each LED string and a first duty cycle associated with the first current; and
a control logic coupled to the modulator, and, based on digitized information of the first current from each LED string, configured to provide digitized information of second current which includes two choices for each respective LED string so as, over the second current flowing through each LED string, to decrease a magnitude of the forward voltage drop;
wherein the digitized information of the second current for each LED string includes a duty cycle and a current level associated with each second current;
wherein while the control logic chooses first digitized information of the second current, the digitized information of the second current includes the same average current over time of the second current as the average current over time of the first current, and wherein the modulator is to use the digitized information of the second current to operate the respective current sink for each LED string;
wherein while the control logic chooses second digitized information of the second current, the control logic causes a time period during which the second current is active to be equivalent to a time period that is a duty cycle of the first current divided by an integer.
